(19) United States
(12) Patent Application Publication
(10) Pub. No.: US 2017/0208414 A1
(43) Pub. Date: Jul. 20, 2017

(54) METHOD AND APPARATUS FOR ASSIGNING MULTI-CHANNEL AUDIO TO MULTIPLE MOBILE DEVICES AND ITS CONTROL BY RECOGNIZING USER'S GESTURE

(71) Applicant: VALUE STREET, LTD., Seoul (KR)

(72) Inventors: Daehee LEE, SEOUL (KR); Hanjoon AHN, SEOUL (KR)

(21) Appl. No.: 15/476,950

(22) Filed: Mar. 31, 2017

Related U.S. Application Data
(63) Continuation of application No. PCT/KR2015/010411, filed on Oct. 1, 2015.

(30) Foreign Application Priority Data
Oct. 2, 2014 (KR) 10-2014-0133438

(51) Int. Cl. H04S 7/00; H04R 3/12; H04R 25/00; H04L 29/08; H04R 5/04; H04R 5/02; H04W 84/20

(52) U.S. Cl. CPC H04S 7/303; H04R 5/02; H04R 3/12; H04W 84/20; H04L 29/0836; H04R 5/04; H04R 25/407; H04S 2420/00

(57) ABSTRACT

A method or apparatus for multi-channel audio data control using plural mobile devices comprising steps of automatically calculate positions of plural devices, transmit audio data to plural devices based on calculated positions, and execute control based on transmitted audio channel data. Control of the data can be executed by automatically decided or by recognized user gestures from the mobile devices.

### CROSS-REFERENCE TO RELATED APPLICATIONS

The present application is a bypass continuation application of currently pending international application No. PCT/2015KR/010411 having an international filing date of 1 Oct. 2015 and designating the United States, the international application claiming priority to an earlier filed Korean patent application 10-2014-0133438 having a filing date of 2 Oct. 2014. The entire contents of both the aforesaid international application and the aforesaid Korean patent application are incorporated herein by reference. The applicant claims the benefit of and claims priory herein to both the aforesaid international application and the aforesaid Korean patent application and their filing dates and priority dates.

### BACKGROUND OF THE INVENTION

### Field of the Invention

The present invention is related to a method or an apparatus for transmitting audio data to plural mobile devices and control by automatically detecting positions of plural mobile device.

### Related Art

A 5.1 ch surround audio system, e.g., a home theater system is an expensive and fixed speaker system with front, rear speakers and woofer, which are assigned with fixed audio channel and these channels are assigned at the beginning with manual setting from the central control unit by a user. For now, it is possible to connect each speakers with a central control unit using wireless network connection using Bluetooth/Wi-Fi, but each channel needs to be matched manually and new setting for synchronization is needed for each movement of a speaker. Furthermore, the current method of synchronizing sound field is limited to assuming positions of fixed speakers and a user to amend delay of audio signals.

Functions of the surround system, that selectively reproduces and automatically transmits audio data when a user approaches to a device and control the system easily with gestures, have never been suggested before.

### SUMMARY OF THE INVENTION

In recent years, smart mobile devices are implemented with high technology functions with a loud speaker which can reproduce sound up to 20,000 Hz, an advanced microphone and a gyro scope which can recognize motions of mobile devices. Also, a data transmission between mobile devices has never been easier with WiFi/Bluetooth. Thus, what is needed is a method and an apparatus for data control and data communication between smart mobile devices in accordance with a preferred embodiments of the present invention.

### BRIEF DESCRIPTION OF THE DRAWINGS

FIG. 1 is a block diagram of a mobile device in accordance with one or more embodiments of the present invention.

FIG. 2 is a flow diagram of a method for assigning multi-audio channel to plural mobile devices based on position of plural mobile devices.

FIG. 3a is a flow diagram of a method for calculating positions of mobile devices in a network by a master device and assigning audio-channel based on calculated position.

FIG. 3b, FIG. 3d, and FIG. 3e are schematic diagram of a description for data transmission between a master device and other devices in a network.

FIG. 3c is frequency changes of reflected waveform of inaudible high frequency by user gestures, or user movements.

FIG. 4 is a flow diagram of a method for requesting slave devices for distance calculation signal transmission from a master device and assigning channels from the master.

### DESCRIPTION OF EXEMPLARY EMBODIMENTS

In various embodiments, the first embodiment may comprise a method of a user position detection and gesture recognition for audio data control using plural mobile devices.

A mobile device may have a transceiver, which contains long distance wireless communication module for voice call and short distance wireless communication module for network formation or position calculation of surrounding devices.

The mobile device may have a speaker (loud speaker), to regenerate audio or to transfer inaudible high frequency for transmitting distance calculation data to surrounding mobile devices and detecting user position and gesture, and a microphone, to receive inaudible high frequencies from surrounding mobile devices and reflected signals for user position and gesture recognition.

According to one of embodiments of the present invention, the mobile device may have a sensor module that contains an accelerometer to detect its position change, a gyroscope, an image sensor, and a magnetometer to detect user's moving direction.

According to one of embodiments of the present invention, the mobile device may also have a memory module to save audio data, and a CPU to control above mentioned modules.

According to one of embodiments of the present invention, plural mobile devices form a wireless network each other, using short distance wireless communication module such as Bluetooth and Wi-Fi. The mobile devices generate signals for distance calculation, receive reflected signals from the generated signals, and calculate distance and position of each device using time difference between generating and receiving signals, triangular measurements and characteristics of frequency difference of received signals. When controlling audio channel data, at least one of the mobile devices may detect whether a user is moving or not and decide audio regeneration from mobile device, and recognize one of various user's control gestures representing regeneration, pause, next, previous, etc.

The method of detecting user position and recognizing control gesture includes, receiving reflected signal of inaudible high frequency, generated by the speaker, at the microphone or a signal detector, and automatically deciding information of frequency change according to the Doppler effect or recognizing transmitted signal from an accessory device held by a user or the magnetometer sensor.

When transmitting audio data to plural mobile devices, regeneration time synchronization information can be contained.

When any motion of at least one of the mobile devices is detected by the gyro sensor, image sensor, or any contained sensor modules during regeneration of audio data, decision of recalculation of device position is performed with volume control, audio channel control for regeneration time synchronization without user controls. If the position change range is more than a certain threshold value or any mobile device receives a call, at least one of the mobile devices (a master device) should detect stopped device/devices to retrieve channel of the stopped device/devices and re-assign its channel to another device or other devices.

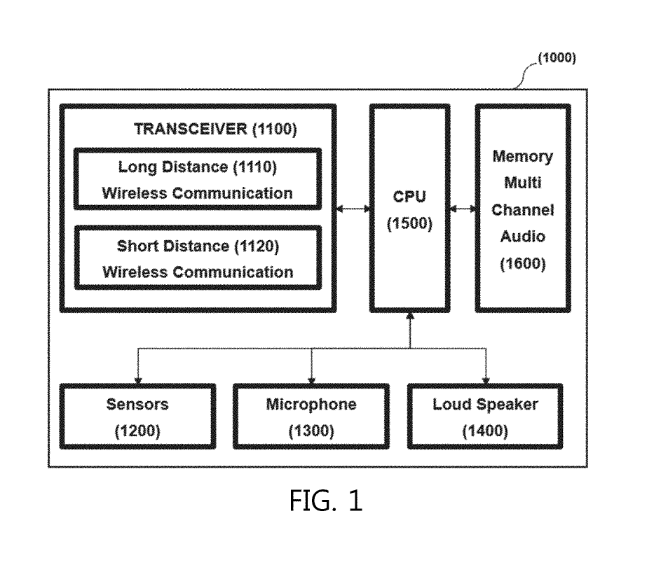

FIG. 1 is a block diagram of a mobile device in accordance with one or more embodiments of the present invention.

FIG. 1 is a suggesting an implementation of the mobile device which can have functions of a multi audio channel assignment and audio data control by gesture recognition for plural mobile devices. The mobile device (1000) may have a transceiver (1100), which contains at least one of a long distance wireless communication module (1110) for voice call or a short distance wireless communication module (1120) for network formation with surrounding devices. In other words, each mobile device may receive and transmit saved calculated distance signal through the wireless communication module to each other. For example, Bluetooth/Wi-Fi communication must get through the master device when there is a communication between nodes for transmitting data, so other communication method may be used such as an Ad-hoc or a Mesh network when direct communication between each node is needed.

According to one of embodiments for distance calculation method of the present invention, if one of the devices transmits inaudible high frequency signal to other devices through its speaker (1300), other devices may receive inaudible high frequency through high specification microphone for distance calculation.

Furthermore, signals for distance calculation may broadcasted from each device to other devices. In other words, each mobile device may broadcast the signals for distance calculation in the formed network.

The mobile device may have a microphone (1200), to receive a reflected inaudible high frequency signal for calculating a relative distance of at least one of surrounding devices or for recognizing user gesture, and a speaker (1300), e.g., a loud speaker for reproducing sound using audio data, transmitting a gesture recognition signal and a distance calculation signal to devices in a network using a inaudible high frequency signal. The speaker may produce at least 20,000 Hz of inaudible frequency.

Also, the mobile device (1000) may have a sensor module (1400) that contains an accelerometer to detect its position change, a gyroscope, an image sensor, accelerometer for user movement detection and a magnetometer to detect user's moving direction.

Also, the mobile device (1000) may also have a memory module (1500) to save multi-channel audio data, and a CPU (1600) to control above mentioned modules.

According to one of embodiments of the present invention, a mobile device, for reproducing multi-channel audio data, may have a memory for saving multi-channel audio data, a transceiver for forming network with surrounding plural mobile devices, a speaker for reproducing multi-channel audio, a microphone for receiving sound and a CPU.

The CPU controls a network formation with surround plural mobile devices, receives signals from the mobile devices for distance calculation and user detection, calculates positions of the mobile devices based on received signal information, and assigns at least one audio channel to the plural mobile devices based on the calculated position information.

Also, the mobile device CPU for reproducing multi-channel audio may also transmit calculated distance signal to at least one second device in the formed network by a request of the first device, saves received signal from the second device, calculate distance between the second device by request of the first device, transmit calculated data to the first device, receive channel assignment from the first device, and reproduce transmitted audio data with assigned audio channel. In the present invention, the first mobile device may called as a master device, and the second device may called as a slave device. Also, there is a sub-master device which performs data transmission between the first and the second.

Also, in accordance with one embodiment, the CPU may control actions of the mobile device based on user gesture information. For example, reproducing audio data from the mobile device may be controlled with gestures.

According to one of embodiments of the present invention, the mobile device may also have a gyro sensor for position change of itself and a magnetometer sensor for user position detection.

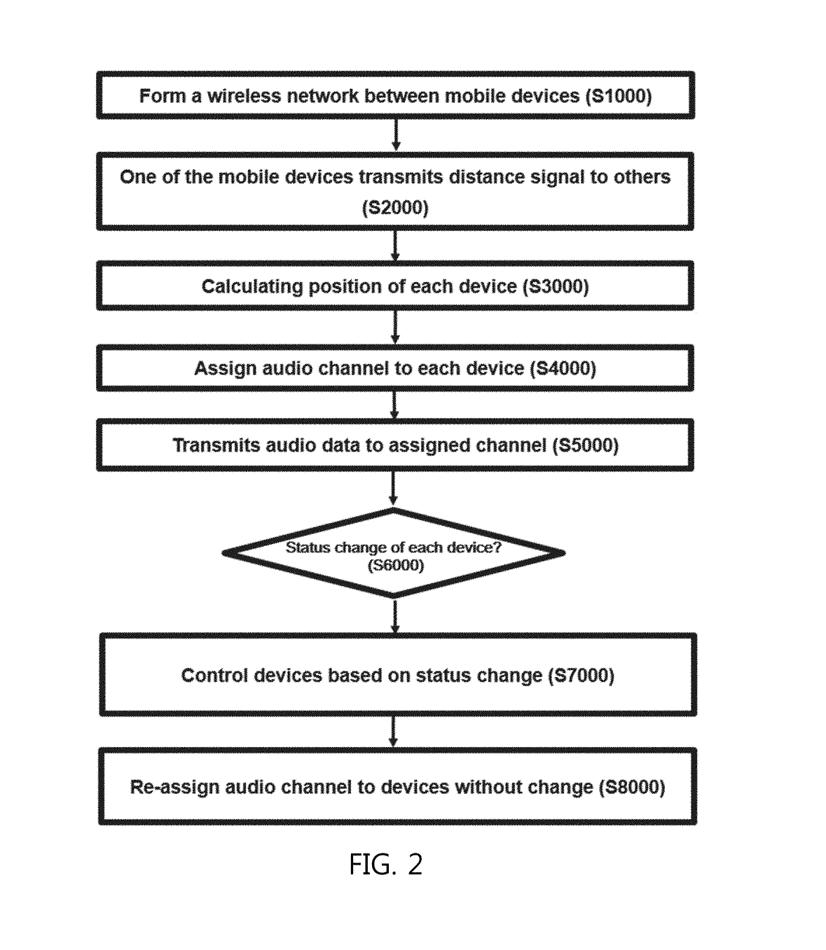

In accordance with one embodiment, FIG. 2 is a flow diagram of assigning multi-audio channel based on positions of plural mobile devices.

According to one of embodiments of the present invention, plural mobile devices may form a network (S1000) each other using short-range wireless communication module (1120) such as Bluetooth or Wi-Fi. Any device from the plural mobile device may transmit signal for distance calculation in the network (S2000). The distance calculation may calculated by checking time differences of transmitting and receiving. The calculated distance may be consolidated for position calculation of each device in one device from the plural mobile devices (S3000). This mobile device may be called as a master, a master mobile device, or a master device. The master device may assign multi-audio channel to each device based on calculated distance information (S4000). For multi-channel audio, it could be in various forms such as 5.1 channel surround system and multi-track audio with various sound effects for each speaker. Through the assigned channel, Audio data may be transmitted between mobile devices. Audio data may be transmitted to each assigned channel (S5000). The audio data may include information for reproducing time synchronization information between audio channels. Each mobile device may be monitored periodically or consistently for status change of each mobile device (S6000). For example, the master device may monitor each device's status change in every 3 seconds. This monitoring may be performed only if the status change of device is a defined event. The defined events may include, movement detection of a user using inaudible high frequency for position detection or gesture recognition, position change of mobile devices using distance calculation signal and detecting signals, such as incoming call from the long distance communication module. Also, when any movement of mobile devices has been detected using gyro sensor, the mobile device may automatically decide to stop reproducing audio data and transmit monitoring results of such event to the master device. The mobile device function may be controlled based on status change of the mobile device (S7000). For example, connection to the audio channel may be disconnected from the mobile device, if the defined event has been occurred.

In accordance with an embodiment of the present invention, audio channels may be re-assigned to devices in the network except a mobile device with an event.

In other words, steps of a method for assigning multi-channel audio to plural mobile devices are as follows: a step of forming a network between plural mobile devices; a step of transmitting signals for distance calculation each other; a step of calculating positions of other devices by the first device in the network; and a step of assigning at least one channel to a mobile device by the first mobile device. Audio data may be controlled by mobile devices through the assigned channels.

Signals for distance calculation of plural mobile devices may be different frequency for each device and received signal by at least one second device in the network may be transmitted to the first mobile device in the network.

Reproducing time synchronization information between plural mobile devices may be included in the audio data that is transmitted through the formed wireless network.

Also, audio data controls are as follows: play, pause, stop, next, previous, and play list control.

The audio data may be controlled by transmitting inaudible high frequency signal from a mobile device to a user, receiving reflected signal from the user and recognizing the user's gestures.

The audio data may be controlled solely based on recognized gesture even there were a user's manual control.

If any change in position of one device from the plural mobile devices is detected, a re-assigning of audio channel to the plural mobile device may be decided based on the detected change in position. Steps may be performed in accordance with aforementioned explanation.

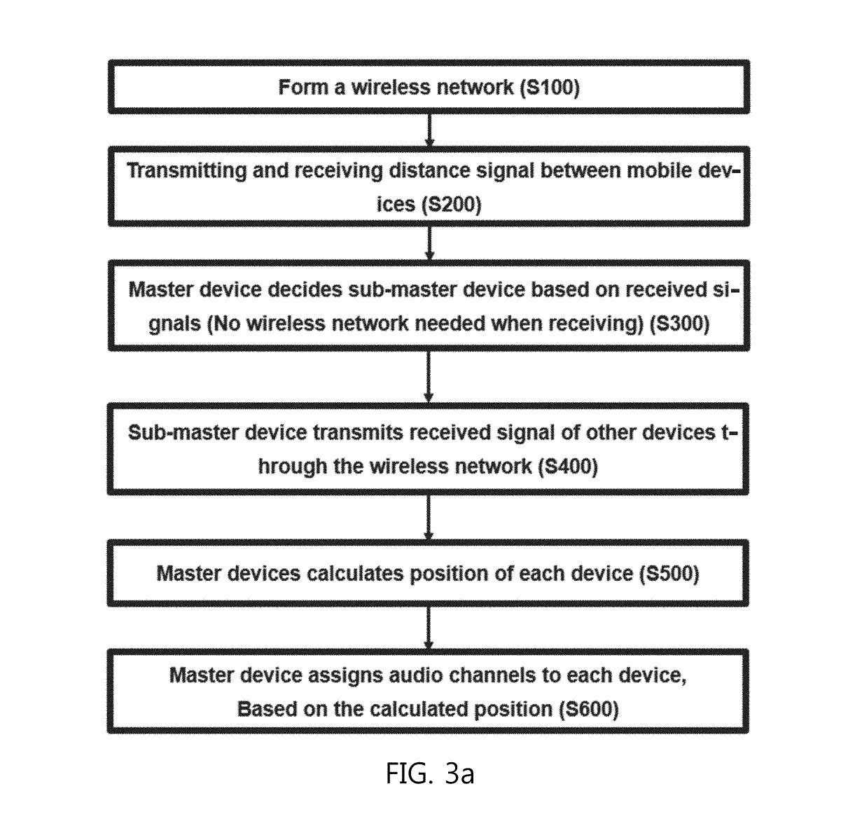

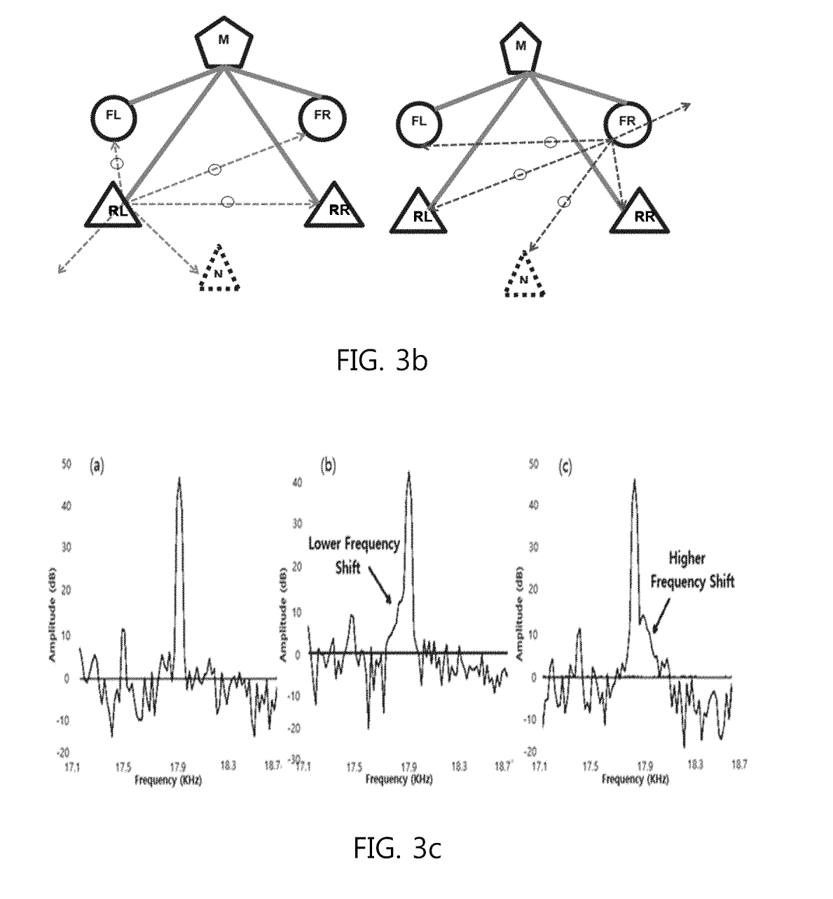

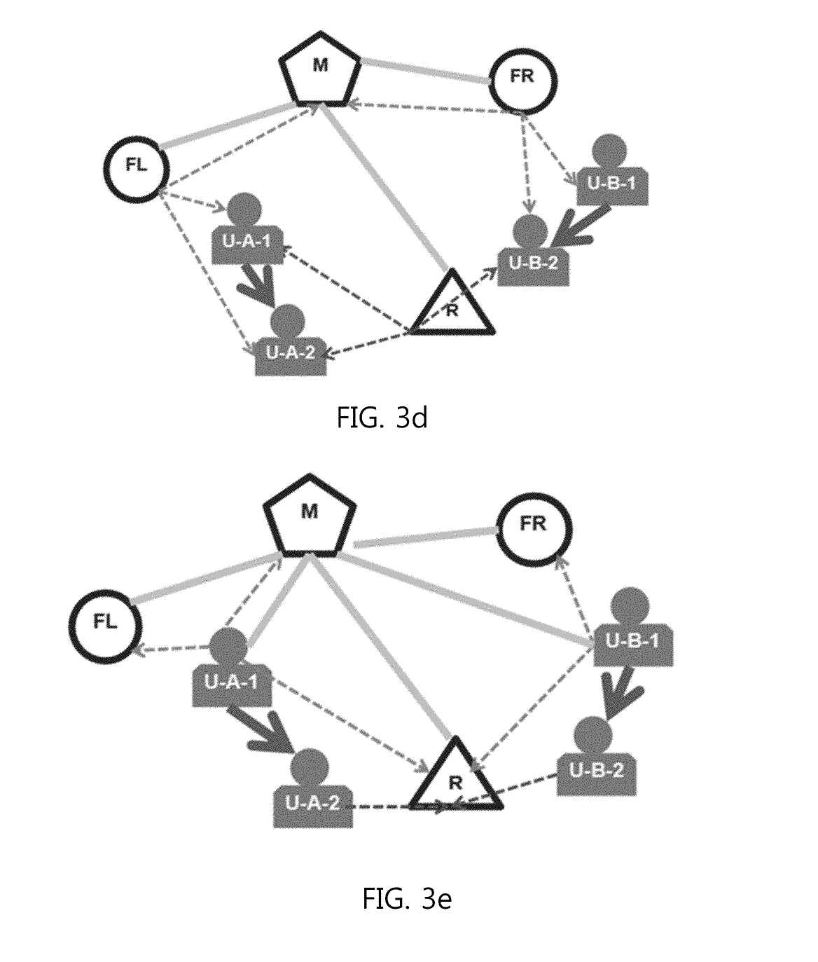

FIG. 3a is a flow diagram of a method for a master device calculating positions of slave devices in a network and assigning audio channel based on calculated position.

The wireless network may be formed between the plural mobile devices (S100). The wireless network may formed by pivoting the master device. The master device may perform as an access point (AP), decide connection of between mobile devices, and decide receiving and transmitting data between the master device and other devices. In the present invention, the master device may perform as an AP, assign audio channel to reproduce multi-channel audio, and control audio data through assigned audio channel. From the plural mobile devices, one mobile device may transmit distance calculation signal to other devices. The master may be a device that function as an AP and other mobile devices may be called as slave, slave mobile device, or slave devices which could answer to a request, transmit a data, and receive channel assignment from the master. The data may include calculated distance between mobile devices and distance calculation signals.

Further description of the embodiment is as follows: the system may use wireless network, such as Wi-Fi or Bluetooth; each mobile device are connected to wireless network; and inaudible frequency may be used for distance calculation between each mobile device.

The master device may function as an access point in the formed network. The master device may assign frequencies that slave devices use and to itself And then, the master device may request signal transmission to each mobile device using inaudible high frequency or Wi-Fi wireless signal. The master device may decide sub-master device by determining the closest and the farthest device from it, based on received inaudible frequency signal from each device. The master device may request saved data from sub-master device to minimize calculation data for distance of each device.

Transmitted information may include transmission time information of sub-master device and time signal information of other slave devices. The master device may calculate relative distances between devices in the network. The master device may assign audio channel and transmit audio data through the assigned channel based on calculated relative positions. Advantages when using inaudible high frequency are following:

Battery life will be increased compared to using wireless network between mobile devices.

Signal interruption will be decreased between mobile devices, since each mobile device are assigned with unique inaudible high frequency.

Also, there could be more advantages, when assigning different frequencies to mobile devices for distance calculations each other.

Unlike Wi-Fi/Bluetooth communication, transmitting and receiving could be performed at the same time.

Unlike Wi-Fi/Bluetooth communication, direct communication between mobile devices is possible without an access point (AP).

When transmitting and receiving with assigned frequency to a mobile device, communication organization may be simpler since the mobile device only need to respond to its own frequency. However, assigned frequency to each mobile device information must be informed to the mobile device beforehand.

With the assigned inaudible high frequency, a mobile device may create different messages in a form of unique code for bi-directional communication. A Morse code could be one example of the unique code and may be created by inaudible high frequency.

Aforementioned information will be further explained below, refer to FIG. 3b and FIG. 3e. FIG. 3b or FIG. 3e is a schematic diagram for explanation of data transmission between a master device and other devices in a network.

FIG. 3b is formed with a master device (M), a front-left (FL), a front-right (FR), a rear-left (RL), a rear-right (RR) and a new device (N). When calculating distances of each devices using Wi-Fi, it is impossible to measure distances between RL-FL, RL-FR, RL-RR, since direct communication between devices is not supported. However, if the inaudible frequency is used to distance measurement with broadcasting signals from RL or FR like FIG. 3b, it is possible to receive time signals from every surrounding devices in the network. Also, it is possible to determine which devices transmitted signals, if a unique frequency has been assigned to each device. Therefore, if every slave devices (FL, FR, RL, RR) transmit distance information to the master device after transmit signals for distance measurement and then save received signals from other devices, the master device is now able to calculate relative position of each device. Also, the master device may determine the closest and the furthest device and calculate positions of mobile devices using determined devices to minimize calculation data amount. In conclusion, the master device may assign audio channel to each device based on calculated positions of plural devices and transmit audio data refer to the assigned audio channel. Also, it is easy to assign new audio channel to a new device (N) in FIG. 3b, and it is possible to re-assign audio channels for moved device since movements of devices may be detected by its sensors.

A method of recognizing user gesture using inaudible high frequency, in accordance with one of the embodiments of the present invention, could be explained refer to FIG. 3c.

FIG. 3c is a reflection waveform diagram of inaudible high frequency for user gesture recognition.

The Doppler Effect may be used for gesture recognition using inaudible high frequency. The Doppler Effect is a frequency changing effect when a user gets closer or further from a microphone. Also, amount of frequency change is relative to speed of an object.

When there is no movement of the user like FIG. 3c, a reflected waveform is detected as a one peak like (a) of FIG. 3. When the user gets further, the reflected waveform moves to a lower frequency range like (b) of FIG. 3c and when the user gets closer, the reflected waveform moves to a higher frequency range like (c) of FIG 3c. Therefore, user gesture could be recognized by analyzing reflected waveform.

It is simpler to use inaudible high frequency for gesture recognition than using infrared camera since it is applicable with pre-installed microphone and speaker in a mobile phone with reduced calculation amount, and it is also applicable with wireless speaker with additional microphone.

According to one of embodiments of the present invention, explanations of the position detection method are as follow:

FIG. 3d. is formed with a master device (M), a front-left speaker(FL), a front-right speaker (FR), a rear-left speaker (RL), a rear-right speaker (RR), the first position of A-user (U-A-1), the second position of A-user (U-A-2), the first position of B-user (U-B-1), and the second position of B-user (U-B-2). Also, each devices are connected with wireless network, such as Wi-Fi, the master device assigned unique frequency to each device. At the moment, the FL speaker is the closest when the A-user is positioned at U-A-1. At this situation, the FL speaker and RR speaker transmit inaudible high frequency and receive reflected signal from each device to detect user presence. Based on user detection, FL and RR device may transmit related information to the master device and the master device decides the closest device from the user to send resultant information to a corresponding device.

Another embodiment is when A-user moves from U-A-1 to U-A-2 and the closest device becomes the RR device. At the same time, when B-user moves from U-B-1 to U-B-2, the closest device to B-user becomes RR devices. At this moment, user level is considered for determine which user to control RR device. If A-user has a higher level for device usage and when A-user moves from U-A-1 to U-A-2 while listening to an audio from the FL device, the master device controls the audio data listened by A-user to be reproduced from the RR device. Therefore, B-user does not have a permission to control the RR device if A-user is at the present.

FIG. 3e is represents when a user is wearing/holding an accessory device. An accessory device may include a transceiver for wireless network, a speaker, and a microphone. The wearing/holding accessory device may connected to a network to receive audio channel or assigned frequency information of other devices from a master device.

A difference between the FIG. 3d and the embodiment is that a wearing/holding accessory device transmits signals to mobile devices (FL, FR) with its unique frequency when a user is near each mobile device. Mobile devices (FL, FR) may receive the signals and create position information of A-user and B-user. Also, when both A-user and B-user get close to the RR device at the same time, a user with higher usage level, may have permission to control audio data of the RR device. For this, the master device or the RR device may request ID of each users' accessory device for distinguish level and each accessory device may answer with its unique assigned frequency.

The master device may store audio data in its storages, but its main function is to detect position of each device, therefore, it may request audio data transmission to slave devices through their assigned channels if the data is stored in another device. The master may receive signals from slave devices after the slave devices receive requesting message for distance calculation. The master device may calculate distance between devices using received signals. The method for distance calculation is calculating difference between signal transmission time from slave devices and receiving time from the master and may also calculated by using frequencies of signals. Frequencies of signals may be transmitted through the Wi-Fi or Bluetooth, which is used to form the network, or other frequencies, such as inaudible high frequency that is over 20,000 Hz. A high specification microphone may detect inaudible high frequency.

Also, the plural mobile devices may receive and transmit distance calculation signals each other (S200) and these signals may be stored in each device. When each mobile device transmits stored plural signals to the master device, it may acquire the signals itself from received signals from other mobile devices. However, if every signal is transmitted to the master, there are too much of unusable data and overload of position calculation process may occur. Therefore, the master device could receive signals of distance between slave devices only from pre-defined mobile devices. To make this happen, the master device may decide a sub-master device by receiving plural distance calculation signals (S300). The sub-master device may be called as a sub-master.

For example, the master device may receive distance calculation signal from the sub-master that is decided through distance calculation. Decision of choosing sub-masters is about the distance between the master and slave devices, for example, the closest and the furthest mobile devices may be assigned as sub-master devices and transmit distance information between slave devices. The distance calculation signal that is stored in sub-master devices may be transmitted to the master device (S400). When there is a request of distance calculation signal from the master, sub-master devices may transmit the signal to the master as an acknowledgement. The master may use directly received distance calculation signals from slave devices and indirectly received distance calculation signals from sub-master devices to calculate positions of mobile devices (S500). Positions may be calculated directly from the master device using matrix equation or indirectly calculated from outside server and receive results. The master device may assign surround audio channel to each mobile device to make effects like multi-channel audio system using calculated position information of plural mobile devices (S600). It may transmit audio data to at least one mobile device through assigned channel. The transmission may occur through the formed network. In other words, steps of the method for assigning audio channel from the first mobile devices to at least one mobile device from plural mobile devices in accordance with an embodiment of the present invention are as follow: a step of forming network between the plural mobile devices; a step of requesting distance calculation signals to the plural mobile devices in the network; a step of receiving the signals from the plural mobile devices; a step of transmitting distance calculation information to at least one mobile device except the first mobile device; a step of calculating positions of the plural mobile devices using received signals and information; a step of assigning audio channel to each device based on calculated position; and a step of deciding re-assignment when there is a detection of movement of any device from the plural mobile devices.

The step for requesting distance calculation signal to plural mobile devices may include deciding order of signal transmission of each mobile device.

The method, in accordance with an embodiment, may include steps of calculating distance between each mobile device using received signals from plural mobile devices, and deciding the furthest and the closest device.

Also, the method may also include deciding a mobile device for transmitting and receiving distance calculation information. Steps of the embodiment may be performed as aforementioned descriptions.

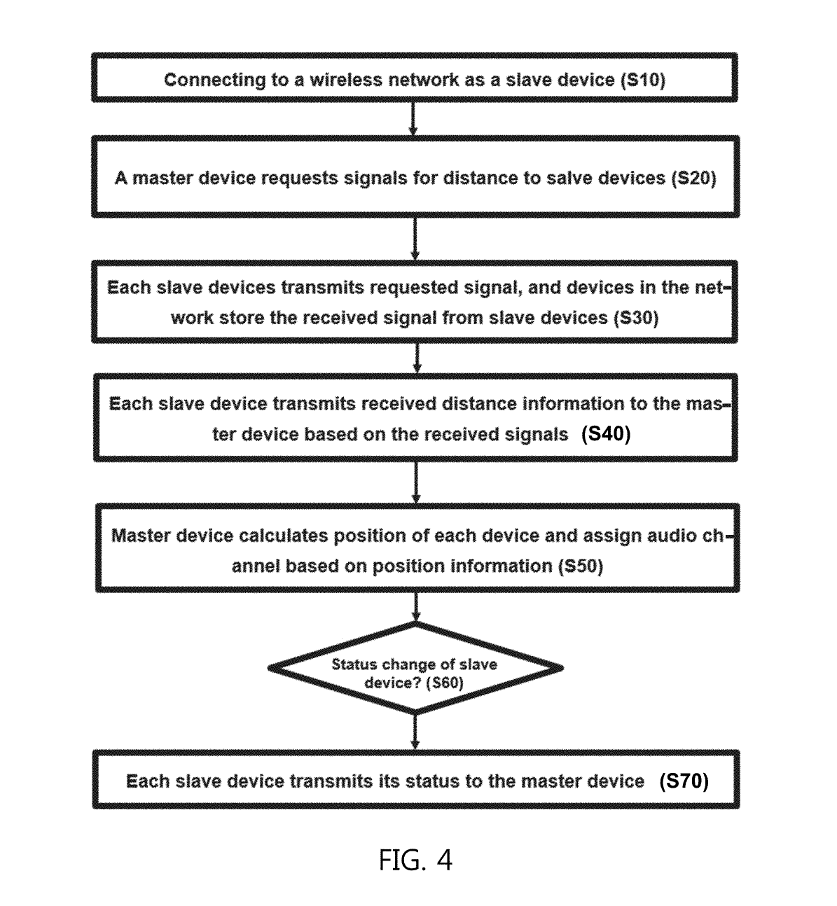

FIG. 4 is a flow diagram of a slave is being requested for distance calculation signal from a master and being assigned a channel by transmitting signal from the master.

The slave device may request a connection to the master device, e.g., AP to be connected to the wireless network (S10). The slave device may be connected to the wireless network only if it has permission from the master device. A method of channel assigning from the master device by answering signal request is shown by FIG. 4. After the formation of a network, the master device may request for distance calculation signal to each slave device (S20). This request may be transmitted to slave devices from the master in form of message by using wireless network or unique frequency signal of the master device. When the master device requests signal transmission to slave through the wireless network, the requests may include parameters for signal transmission such as order of transmission or frequency assignment. Signals from each slave device may be stored in each device in the network. Signals that are transmitted in the network may be stored in at least one device from the master and slave devices.

Each slave device may transmit stored signal information to the master device by request from the master device (S40). This transmission may be optimized like S400 of FIG. 3a. In other words, only selected devices as sub-master may transmit stored signal information to the master like S400 of FIG. 3a. The master device may calculate position of each device using received related distance calculation information from every slave device or selected sub-master device and assign audio channel to each mobile device based calculated position information (S50). Also, status change of slave devices may be monitored periodically or consistently like aforementioned description (S60). This monitoring may be decided by checking if the status change is predetermined events or not. Occurrence of any event is may be decided by the master device, the sub-master device, or the slave device. If decision of event occurred by slave device, the decision is transmitted to the master device, the master device may decide re-assignment of audio channels (S70).

In other words, a method for audio assigning of the second device from plural mobile devices comprising steps of: a step of connecting to a network formed by the plural mobile devices; a step of being requested of distance calculation signal from a mobile device in the network; a step of transmitting signals for distance calculation to the requesting devices; a step of transmitting stored information to the first mobile device from the plural mobile devices; a step of being assigned of an audio channel from the first mobile device and receiving audio data through the assigned channel; and a step of transmitting status change of any mobile device to the first mobile device, if there are changes of position from the second mobile device.

When receiving a request of transmitting distance calculation signal from at least one mobile devices in the network, the signal may be transmitted in order of assigned signal to the second mobile device.

Also, the stored information may be transmitted after receiving a request from a device of the plural mobile devices. Steps in the embodiment may be performed as aforementioned descriptions.

Related to methods and apparatuses in embodiments of the present invention, aforementioned methods may be applied. Therefore, the same information about apparatuses with aforementioned methods, have been omitted.

Aforementioned explanation of the present invention is just for exemplary and it may be easy to understand, for those who have knowledge in the field, that the present invention could be applied in several embodiments without changing core characteristics or technology fact. Therefore, embodiments of the present invention are not limited to aforementioned embodiments.

Limitation of the present invention may be represented in the patent claim limitation instead of detailed embodiments, and every transformed or changed method that are deducted from the patent claim limitation, may be interpreted as inclusion of the present invention.

What is claimed is:

1. A method of operating a plurality of networked devices, the method comprising:
transmitting, by a first slave device, first mechanical signal via a first assigned channel;
receiving, by a second slave device, the first mechanical signal;
transmitting, by the second slave device, a second mechanical signal via a second assigned channel;
receiving, by a master device, the first mechanical signal and the second mechanical signal;
processing, by the master device, the first mechanical signal and the second mechanical signal to determine relative position of the first slave device;
transmitting, by the master device, a control signal for the first slave device, the control signal corresponding to the relative position;
receiving, by the first slave device, the control signal; and
applying, by the first slave device, the control signal in its operation.

2. The method recited in claim 1 wherein the control signal comprises audio channel assignment for the first slave device.

3. The method recited in claim 1 wherein operation of the first slave device comprises audio playback.

4. The method recited in claim 1 wherein the first slave device comprises a speaker and a microphone.

5. The method recited in claim 1 wherein the first slave device is a mobile device.

6. The method recited in claim 1 wherein the first channel comprises a first range of inaudible frequencies and the second channel comprises a second range of inaudible frequencies, the first range different than the second range.

7. The method recited in claim 1 wherein the first assigned channel comprises frequencies that are outside of human audible spectrum.

8. The method recited in claim 1 further comprising the step of transmitting, by the master device, channel assignments to the first slave devices.

9. A system comprising a plurality of networked devices, the system comprising:
a first slave device operable to transmit a first mechanical signal via a first assigned channel;
a second slave device operable to receive the first mechanical signal and to transmit a second mechanical signal via a second assigned channel, the second mechanical;
a master device operable
to receive the first mechanical signal,
to receive the second mechanical signal,
to process the first mechanical signal and the second mechanical signal to determine relative position of the first slave device, and to
transmit a control signal for the first slave device, the control signal corresponding to the relative position; and
wherein the first slave device is further operable
to receive the control signal, and
to apply the control signal in its operation.

10. The device recited in claim 1 wherein the control signal comprises audio channel assignment for the first slave device.

11. The device recited in claim 1 wherein operation of the first slave device comprises audio playback.

12. The device recited in claim 1 wherein the first slave device comprises a speaker and a microphone.

13. The device recited in claim 1 wherein the first slave device is a mobile device.

14. The device recited in claim 1 wherein the first channel comprises a first range of inaudible frequencies and the second channel comprises a second range of inaudible frequencies, the first range different than the second range.

15. The device recited in claim 1 wherein the first assigned channel comprises frequencies that are outside of human audible spectrum.

16. The device recited in claim 1 wherein the master device is further operable to transmit channel assignment to the first slave devices.

17. A device operating within a network of devices, the device comprising:
a speaker operable to transmit a first mechanical signal via a first assigned channel;
a microphone operable receive a second mechanical signal via a second assigned channel;
a processor operatively connected to said speaker and said microphone, said processor configured to cause the speaker to transmit a third mechanical signal via the first assigned channel, the third mechanical signal having information related to the second mechanical signal;
the microphone operable to receive a control signal;
the processor configured to apply the control signal in an operation of the device.

18. The device recited in claim 17 wherein the control signal comprises audio channel assignment for the device, and wherein the operation of the device comprises audio playback.

19. The device recited in claim 17 wherein the control signal is received via the first assigned channel.
